(19) United States
(12) Patent Application Publication
(10) Pub. No.: US 2010/0282633 A1
(43) Pub. Date: Nov. 11, 2010

(54) LAMINATED AND THERMOFORMED ARTICLES CONTAINING OXYGEN SCAVENGER

(75) Inventors: Chieh-Chun Chau, Victor, NY (US); Samuel A. Incorvia, North Tonawanda, NY (US); Thomas H. Powers, Mayville, NY (US); Stanislav E. Solovyov, Getzville, NY (US)

Correspondence Address: Stephen B. Salai, Esq.;Harter Secrest & Emery LLP, 1600 Bausch & Lomb Place, Rochester, NY, 14604-2711, US

(73) Assignee: Mulstisorb Technologies, Inc., Buffalo, NY (US)

(21) Appl. No.: 12/777,835

(22) Filed: May 11, 2010

Related U.S. Application Data
(63) Continuation-in-part of application No. 12/416,685, filed on Apr. 1, 2009.
Application No. 12/416,685 is a continuation-in-part of application No. 12/719,160, filed on Mar. 8, 2010.

(51) Int. Cl. B65D 81/24; B32B 37/14; B65D 90/02

(52) U.S. Cl. 206/524.3; 156/244.11; 206/524.4

(57) ABSTRACT

A well dispersed oxygen scavenging particulate compounded in a polymer matrix. The oxygen scavenging formulation consists of iron powder with a mean particle sizes within 1-25 um and pre-coated with at least one or more activating and acidifying powdered compounds, usually in the form of solid organic and inorganic salts of alkaline and alkaline earth metals such as sodium chloride and sodium bisulfate. The pre-coated iron particulate is dispersed into a polymer resin by using a conventional melt processing method such as twin-screw extrusion. The oxygen scavenging compound is mixed with polymer pellets in the solid state prior to melting. The polymer resin pellets and the coated iron powder are preferably treated with a surfactant in the dry state to help dispersing the iron/salt powder with the resin pellets. The melt extruded compounds are pelletized and kept in the dry state to prevent premature activation.

### CROSS REFERENCE TO RELATED APPLICATIONS

this application is a continuation in part of Ser. No. 12/416,685 filed Apr. 1, 2009 and a continuation in part of Ser. No. 12/719,160 filed Mar. 10, 2010.

### BACKGROUND OF THE INVENTION

1. Technical Field

This invention relates to surfactants useful for treating the resin pellets or coated iron powders in order to maximize dispersion that include lubricants such as mineral oil, fatty acids such as stearic acid, and low molecular weight compounds such as waxes, lidding films made from such materials and containers especially containers for food products made with such films. This invention also relates to articles that consist of laminated films that contain oxygen scavenger, articles that are thermoformed from the laminated films or sheets. articles folded from the laminated paper boards, methods of making oxygen scavenging articles for food packaging, sealable and peelable lidding films that contain oxygen scavenger, sealable and peelable lidding films that contain laminated films containing oxygen scavenger, sealable and peelable lidding films that consist of polymer or paper substrates, oxygen scavenging film including iron, electrolytes and optionally other moisture absorbing additives.

Rigid food containers such as meat trays and disposable cups are used broadly in food packaging and food services application.

Conventional trays and containers used in meat or food packaging are usually foamed to reduce the weight yet provide rigidity for packaging and transport. The material is typically polystyrene. Some are polylactic acid and polyolefins.

Another conventional material for making trays or containers are solid sheets that consist of single or multilayer structures. Oxygen barrier materials such as EVOH are often used.

A desirable feature of the containers is to maintain the freshness of the food.

A common method to improve the freshness of a meat package is to remove the excess liquid by using soaking pads. A more effective method is to reduce the oxygen contents inside the package.

It is desirable to make sheets that have oxygen scavenging capability and/or enhanced oxygen barrier properties to preserve the freshness of the food and to prevent microbial growth. Sachets are not applicable for packaging raw meat.

It is another object of this invention to provide a film for making laminated articles on plastic sheet and paper substrates that can be thermoformed or folded to form shaped articles such as containers, bowls, trays, cups and gable top paper boards.

It is a further object of the invention to provide lidding film for packaging of food containers. Lidding film provides clarity, good seal to containers, strength and protection. Lidding film needs to be hand-peelable. It is desirable to have lidding film to possess oxygen scavenging capability to help the food freshness.

A still further object of this invention is to provide laminated structures that contain oxygen scavenger and are useful as lidding films.

The overall advantages of incorporating a layer or layers of active or oxygen scavengers in the thermoformable articles and peelable lidding films include integrating oxygen scavenger into food packaging or container, effective oxygen scavenging without visible packet or sachet, flexible to add to areas that need oxygen scavenging, packaging decoration and differentiation, and convenient for recycle processing

2. Description of Related Art

U.S. Pat. No. 6,503,587 B2 (to Mitsubishi Gas Chemical Co.) describes a multilayer laminate with the oxygen scavenging particles, including iron, sandwiched between layers. This method could cause interlayer adhesion issues that would inevitably impact the mechanical and consumer properties of the package.

U.S. Pat. No. 6,821,594 B2 (to Mitsubishi Gas Chemical Co.) describes an oxygen absorbing label method with a protruding structure.

U.S. Pat. No. 6,559,205 B2 and U.S. Pat. No. 7,056,565 B1 (to Chevron Phillips Co.) describes organic-based, branched and pendant cyclic olefinic oxygen scavengers for multilayer containers.

U.S. Pat. No. 7,494,605 (to Cryovac Corp.) describes an oxygen scavenging film with a polymeric oxygen scavenger.

U.S. Pat. No. 6,746,772 B2 (to Mitsubishi Gas Chemical Co.) describes a multilayer film that contains epoxy-curing agents in the film that could result in a stiff and brittle structure.

U.S. Pat. No. 6,063,503 (to Mitsubishi Gas Chemical Co.) describes oxygen absorbing multilayer films that have layer structure and oxygen scavenging particle sizes different from what's described in this invention.

U.S. patent application Ser. No. 12/416,685, filed Apr. 1, 2009 teaches oxygen scavenging films making. The film was extruded from a mixture of 17/3/80 ratio of iron, sodium chloride and low density polyethylene. The film can be a single or multilayer structure by itself with oxygen scavenger located in any layer of the film.

### SUMMARY OF THE INVENTION

In this invention, methods are described to make multilayer oxygen scavenging films that fulfill the above requirements. The methods include extruding fine oxygen scavenging particles (such as those described in U.S. Pat. No. 6,899,822, US Pat. applications 2005/0205841 and 2007/020456, all to Multisorb Technologies Inc., incorporated in their entirety by reference) in a polymer matrix to form multilayer films. The films can be formed as part of the packaging materials or used as labels or as dividers within the package, or as a part of tray or another rigid support for the product within the package. The films can either be directly extruded with the packaging materials, or integrated with the packages by a post-extrusion processing step such as lamination, gluing or taping. The current invention is particularly focused on iron-based powders with a mean particle size of 1-25 um, where iron particles are pre-coated with activating and oxidation reaction promoter particles to form a homogeneous powder. The films or sheets produced with the finely dispersed such oxygen scavenging particles advantageously possess high clarity and high reactivity with oxygen, compared to larger particles (poor clarity and reactivity) and smaller nanoscale particles (poor clarity).

An object of this invention is to provide a well dispersed oxygen scavenging particulate compounded in a polymer matrix. The oxygen scavenging formulation consists of iron powder with a mean particle sizes within 1-25 um and pre-coated with at least one or more activating and acidifying powdered compounds, usually in the form of solid organic and inorganic salts of alkaline and alkaline earth metals such as sodium chloride and sodium bisulfate. The pre-coated iron particulate is dispersed into a polymer resin by using a conventional melt processing method such as twin-screw extrusion. The oxygen scavenging compound is mixed with polymer pellets in the solid state prior to melting. The polymer resin pellets and the coated iron powder are preferably treated with a surfactant in the dry state to help dispersing the iron/salt powder with the resin pellets. The melt extruded compounds are pelletized and kept in the dry state to prevent premature activation.

Another object of this invention is to provide a multilayer extruded film or sheet with the iron-containing compound extruded with a polymer. The film or sheet consists of three layers of the same base resin with the layer thickness ratios varying from 5/90/5 to 25/50/25, and with the middle (active) layer comprising the iron based oxygen scavenger dispersed in a resin. The multilayer film can be unoriented (unstretched), uniaxially or biaxially stretched during or after the processing. The active layer thickness, location with the multilayer structure, and the fraction of oxygen scavenger particulate in it are fine tuned to provide the desired functionality (such as the rate of oxygen absorption, the duration of active barrier protection and transient barrier improvement, or their combination).

Another object of this invention is to provide a product-shaped article from the extruded film or sheet through die cutting, pouch making, bag making, lamination, thermoforming or other converting processes. The article may be in the form of adhered or inserted label or as part of the pouch film to fit the product requirements. In particular, the oxygen scavenging films are laminated, taped, bonded onto one of the inner surfaces of a pouch, or simply stored as an insert in a pouch. Optionally the extruded film or sheet is graphically decorated such that it is compatible with the graphic design of the pouch. Additionally, these materials could be placed on a surface of a rigid container or as lidding stock.

Another object of this invention is to provide a printed or coated object that contains well dispersed oxygen scavengers compounded in a polymer matrix. The object may be a polymer or metallic substrate with the oxygen scavenging compounds printed or coated onto it. In particular, the iron based oxygen scavenger in the polymer matrix can be extrusion coated or solution printed on a polymer film prior to forming a pouch, bag, or a flexible enclosure for food packages, and in particular, the printed or coated pattern is a part of the graphic design of the package.

Another object of this invention is to provide films or sheets that consist of at least a layer of active film laminated on a substrate. The active film contains oxygen scavenger, electrolytes and optionally other moisture absorbing additives such as silica gel, activated carbon and other sorbents. FIG. 1 shows examples of (a) a two layer structure; and (b) a three layer structure of a sheet laminated with active film(s).

Another object of this invention is to provide articles that are thermoformed from the laminated films or sheets for food packaging applications. The oxygen scavenging film is preferably located near the food side of the article. FIG. 2 shows an example.

Another object of this invention is to provide paper or cardboards that are laminated with at least a layer of oxygen scavenging film. The laminates are then converted or folded to form boxes or packages for liquid packaging or moist food packaging.

Another object of this invention is to provide paper or plastic films that are laminated with a least a layer of oxygen scavenging film. The laminates are used as peelable lidding film for containers or packages. The lidding is attached to the container through heat seal or coating seal.

Another object of this invention is to provide a method of making oxygen scavenging articles for food packaging. The method is to laminate oxygen scavenging films to a plastic and paper substrate prior to converting the laminates into food packaging articles.

### BRIEF DESCRIPTION OF THE DRAWING FIGURES

FIG. 1—Oxygen absorption property of FreshBlend nylon films

### DETAILED DESCRIPTION OF THE INVENTION

FIG. 2 is a cross-section of a container made with a film in accordance with this invention.

FIG. 3 is a cross-sectional view of an oxygen scavenging film on a carrier sheet.

FIG. 4 is a cross-sectional view of a substrate having oxygen scavenging films on both surfaces thereof.

FIG. 5 is a cross-sectional view of a thermoformed tray laminated with an oxygen scavenging film.

FIG. 6 is a diagrammatic view of a laminator for making a tray in accordance with the invention

FIG. 7 is a perspective view of two trays made in accordance with the invention.

FIG. 8 is a perspective view of two trays made in accordance with the invention.

This invention relates to methods of extruding oxygen scavenging polymer films that contain finely dispersed oxygen scavenging particulates. The oxygen scavenging film possesses high clarity and tunable oxygen absorption rate. This invention also relates to methods of using such oxygen scavenging films in construction of plastic pouches, bags, flexible enclosures and containers to preserve the freshness of foods and other consumer goods enclosed in the package through absorption of headspace oxygen and/or proving an active barrier to oxygen permeation.

Flexible food packaging materials such as used in a plastic pouch usually require good oxygen barrier properties in order to prevent microbial growth and preserve the freshness of the food. This need can be exemplified by packages such as that for beef jerky, sausages, processed meats, etc. A sachet pack containing oxygen scavenger is commonly used in food pouches to absorb the head space oxygen and to absorb oxygen ingressed through the package wall. Sachets have been used for years in ready-to-serve food packages. However, there are potential disadvantages and limitations associated with the use of sachet. This includes the following:

(a) Sachets are sometimes mistakenly viewed as a part of the food contents and eaten by the consumers.

(b) Sachets are sometimes accidentally cut open causing their contents to spill and contaminate the product when enclosed or fastened to food pouches or packages.

(c) Sachets are sometimes viewed as a nuisance as they disturb the aesthetics and appearance of food packages.

(d) Sachets can not be used for packaging liquid products that require oxygen scavenging.

In accordance with this invention it was discovered that optical properties of polymeric film or sheet substrates such as contact clarity and visible light transmission are advantageously improved if oxygen scavenging particles incorporated into a resin are within 1-25 um in size, and most preferably within 2-5 um in size. Such particles are small enough to be invisible to the naked human eye and at the same time large enough to minimize light scattering by particles of the size comparable to the visible light wavelengths (0.4-0.8 um). The result is a reduced haze of a plastic article into which such particles are incorporated.

Additionally, it was found that a smaller size of composite oxygen scavenging particles (limited by the small particle sizes producing significant light scattering and haze in films), comprising all necessary components for efficient oxidation, produces oxygen scavenging films with higher effective reactivity with permeating oxygen and allows for a more efficient design of barrier structures. Barrier film reactivity is further advantageously improved by multilayer structural designs where the oxygen scavenging layer forms the middle layer of 3-layer structure made from the same matrix resin. The specific optimal layer thickness ratios depend on the overall film thickness and the oxidation kinetics of activated scavenger.

The surfactants useful for treating the resin pellets or coated iron powders in order to maximize dispersion include lubricants such as mineral oil, fatty acids such as stearic acid, and low molecular weight compounds such as waxes.

The reduced iron powder preferably has 1-25 um mean particle size, more preferably 1-10 um mean and most preferably 2-5 um mean. The combination and relative fraction of activating and acidifying components coated onto the iron particles are selected according to the teachings of U.S. Pat. No. 6,899,822, US Pat. applications 2005/0205841 and 2007/020456, incorporated herein by reference. The coating technique is preferably a dry coating as described in the references above.

The film structure is preferably 3 layer or more with the layer ratio in the range of 25/50/25 and 1/98/1, with an optimum ratio depending on the design target (such as the rate of headspace oxygen absorption) with an example ratio being 15/70/15. The coated iron is preferably located in the middle of the three layers.

Films to be used as labels, laminates, lidding films, or inserts for a tray may consist of single or multilayer structure with the coated iron uniformly distributed in the film or in the chosen layer(s). For a multilayer structure, the coated iron is preferably located in the middle of the structure. It can be located adjacent to the external layer to facilitate absorption.

For the printing or coating the coated iron formulation onto a substrate, the coated iron may be formulated in common extrusion coating polymers such as LDPE, EVA, EAA, PP, PS, waxes, emulsions, etc.

The following examples are used to illustrate some parts of the invention:

### Example 1

### Extruded Nylon Films Containing Oxygen Scavenger

An oxygen scavenger package, was prepared by coating iron particulates, 4-5 um mean particle size, with sodium bisulfate and sodium chloride to form a homogeneous coated composite powder. As shown in FIG. 6, this composite powder, abbreviated as “FreshBlend®” oxygen scavenger sold by Multisorb Technologies, Inc. of Buffalo, N.Y., was used for extruding with a nylon 6 resin (Custom Resins Nylene 3411). A Coperion twin screw extruder compounding equipment was used for compounding FreshBlend with the resin. A metering feeder was used for precise feeding FreshBlend powder with the polymer resin prior to melting. The resin pellets were mixed with 0.2 wt % mineral oil (retail pharmacy grade) prior to feeding to the extruder. The extruder was set at 250 C for all the heating zones and a die temperature at 260 C. The FreshBlend was fed at a rate comparable to the extrusion rate to result in weight ratio in the range of 5/95 to 20/80. The extruded strands were air cooled, or optionally water cooled prior to pelletizing.

### Example 2

### Extrusion of Oxygen Scavenging Films

Oxygen scavenging films were made by using the FreshBlend compounds as prepared in Example 1. Three layer films were extruded from a coextrusion blown film line that consists of three extruders, a coextrusion feedblock, and a 2″ annular die and 0.060″ die gap. Films were made with a blow up ratio=2, and various draw down ratios to result in films in the range of 1.5 to 4 mil thick. The films are clear and transparent with little or no visible agglomeration. The films had a layer ratio of approximately 15/70/15 for materials of nylon/FreshBlend nylon blend/nylon for the respective layers. The net oxygen scavenger content was in the range of 1 to 3 wt % through let-down of the oxygen scavenging compounds.

### Example 3

### Oxygen Scavenging Film Performance in Pouch

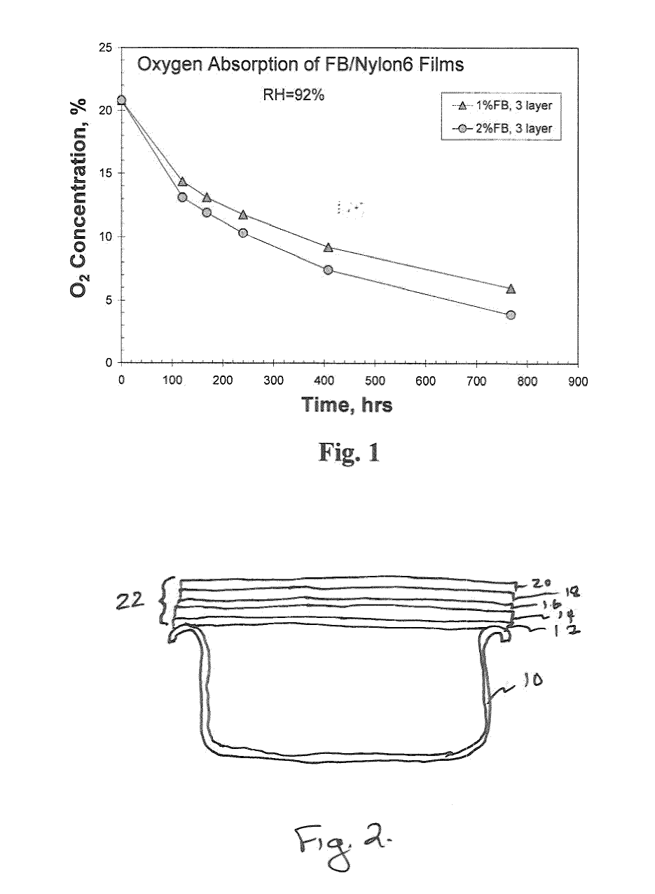

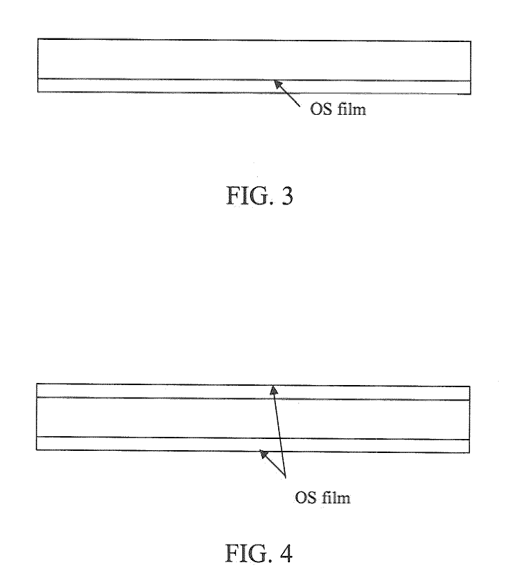

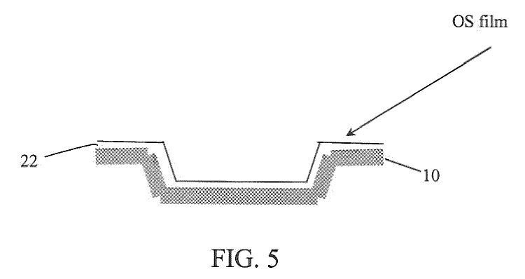

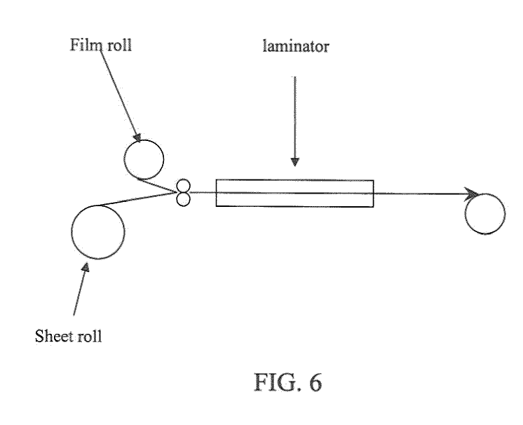

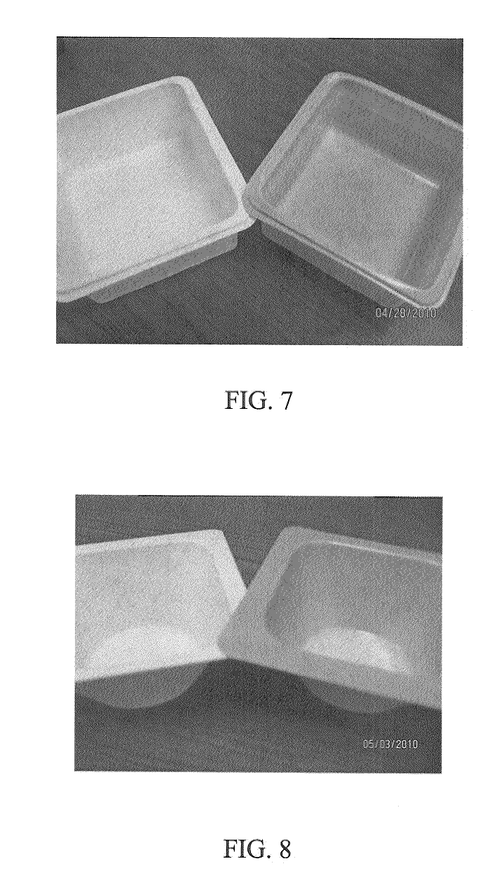

To evaluate the oxygen absorption performance of FreshBlend nylon films working as a label film or insert film in a pouch, the extruded films were cut into stripes and stored in plastic pouches for oxygen absorption property test. The extruded sample films with a chosen weight was cut and stored in a pouch of 6″×6″ dimension. A humidifying agent that delivers 92% relative humidity was also stored in the pouch to activate the oxygen absorption capability by the oxygen scavenger. The pouch was then sealed and subsequently injected 300 cc gas mixture of O2/N2=20/80 into the pouch. The oxygen concentration was measured periodically by using a Mocon model 450 head space analyzer. The oxygen absorption property is shown in FIG. 1. It can be seen that the oxygen concentration decreased gradually with time and with the 2 wt % film decreased at a higher rate than the 1 wt % film. This example demonstrated the utility of the oxygen scavenging film in an enclosure such as a pouch.

FIG. 3 is a cross-sectional view of a container such as a container for a food product made in accordance with this invention. A tray 10 is sealed by a multilayer lidding material. The top layer 20 is a low to medium permeability structural layer for supporting the other layers. Preferably layer 20 is at least somewhat impermeable to oxygen. Layer 18 is a polyester layer on which package printing may appear. Preferably, layer 20 is sufficiently transparent so that the printing on layer 18 is clearly visible. Layer 16 is an optional foil layer that is substantially impermeable to oxygen. When layer 16 is used the oxygen permeability of the structural layer 20 may be less. Layer 14 is oxygen absorbing layer as described herein and layer 12 is an adhesive peel layer that has high adhesion but is nonetheless peelable from the upper lip of the tray 10 for example by pulling a corner thereof and peeling the multilayer structure away from the tray. Preferably, layer 12 adheres at least as tenaciously or more tenaciously to layer 14 as it does to tray 10.

The structural layer 20 may be formed from any suitable material such as Poly Butylene, polyethylene, linear low density polyethylene, or acrylics. The tray 10 may be formed from high density polyethylene, polystyrene or similar materials and may be foamed or semi rigid.

The preferred ranges of materials, formulation, and product structures are as follows.

The reduced iron powder preferably has 1-25 um mean particle size, more preferably 1-10 um mean and most preferably 2-5 um mean. The combination and relative fraction of activating and acidifying components coated onto the iron particles are selected according to the teachings of U.S. Pat. No. 6,899,822, US Patent applications 2005/0205841 and 2007/020456, incorporated herein for reference. The coating technique is preferably a dry coating as described in the references above.

The main polymer for foam is polystyrene and styrene-butadiene copolymers. Other polymers included styrene-ethylene copolymer, polypropylene, polyethylene, polyurethane and their copolymers or derivatives.

The main polymer disclosed in the invention is polylactic acid and its copolymers or derivatives. A preferred derivative is branched PLA or lightly cross-linked PLA. Other biodegradable polymers included polyhydroxyalkanoates (PHA) aliphatic co-polyesters, and its common type polymer of polyhydroxybutyrate (PHB), polycaprolactone, thermoplastic starches (TPS), cellulose and other polysaccharides. All can have their crystallinity varied to a broad range to result in various physical properties.

Sheet substrate—PP, PE, EVOH, PET, Nylon, PLA, PS in single or multilayer format, with the thickness in 10-80 mil, preferably 15-60 mil, that are thermoformable by conventional thermoforming, vacuum forming, hot pressing technologies. The substrate can be single layer or multilayer structure. Examples of substrate structures are 5 layer coextruded sheet such as PE/tie/EVOH/tie/PE or PP/tie/EVOH/tie/PS and the like. “Tie” indicates an adhesive layer that ties two other materials. The substrate can be a 3 layer structure such as (PE+tie)/EVOH/(PE+tie), nylon/EVOH/nylon and the like. It can be a single layer sheet such as PP, PLA, etc produced by extrusion.

Foam substrate—PP, PE, EVOH, PET, Nylon, PLA, PS PLA, PS in single or multilayer format, with a thickness in 10-80 mil, closed cell content 50-100%, cell size 1-1000 micron range, and in any foam density range. The foam substrate can be made of any known foaming agent such as butane, pentane, CO2 and moisture. Examples of foam structure are that of conventional polystyrene foam tray material that has density of 2-5 lb/ft3 and a thickness of 50 mil. The material can be PLA with branching agents or chain extenders.

The oxygen scavenging film is preferably Freshblend films made by following U.S. patent application Ser. No. 12/416,685, filed Apr. 1, 2009. The film was extruded from a mixture of 17/3/80 ratio of iron, sodium chloride and low density polyethylene. The film can be a single or multilayer structure by itself with oxygen scavenger located in any layer of the film structure. Film materials can be polyolefins such as PE, PP, polystyrene, PLA and other common polymers. The Freshblend content can range from 0.5 to 50 wt %, preferably 1 to 10 wt % depending on the needs. Additionally, the deposit of the Freshblend can be patterned in stripes or specific deposits within the Freshblend films in such a way as to provide areas of complete transparency; especially useful in cases wherein the viewing of the product is paramount.

Lamination can be done by using any batch or continuous lamination processing equipments. The lamination time and temperature can be set by following the favorable conditions to achieve the optimum bonding. For extrusion lamination, a ready-made active film may be continuously laminated onto a sheet that is being extruded. Film can also be laminated onto a sheet unwinding from roll stocks.

A lamination process is depicted in FIG. 6.

Optionally an adhesive layer is used to enhance the bonding between the active film and the substrates. The adhesive layer can include maleic-anhydride modified polymers, EVA, EAA, EMA polymer or copolymers, hydroxyl-modified polymers and others.

The following examples are used to illustrate some parts of the invention:

A Freshblend film was made by coextruding a 3 layer structure consisting of LDPE/(PP+PE+Freshblend)/LDPE to make 3.5 mil film. The Freshblend loading is approximately 6 wt % and is uniformly distributed in the middle layer of the film only. A 50 mil polystyrene foam sheet with a density of approximately 3 lb/ft3 was obtained from a commercial source. The film was laminated at approximately 90 C onto the foam with the using of Dow Integral™ 801 adhesive film between the FB film and foam sheet to form a 3 layer laminated structure as shown below:

The laminated sheet was then thermoformed in a single cavity thermoformer to form a 5″×4″×1″ tray as shown in FIG. 6 for two identical samples.

FIG. 7 shows containers thermoformed from Freshblend film laminated polystyrene foam sheets as in the following example.

### Example 2

### Thermoformed Polystyrene Container Containing FreshBlend (FB) Film

The FB film was laminated onto 30 mil high impact polystyrene sheet using the same adhesive film and thermoformed onto 5″×4″×2″ containers as shown in FIG. 7. The FB container on the right is compared with the nonFB container as shown to the left.

A cup was thermoformed by using the same sheet laminates and the product is shown in FIG. 8.

### Example 3

### Thermoformed Barrier Containers Containing Freshblend Film

FB film was laminated onto the following two barrier sheets produced by Spartech:

PE/EVOH/PS—45 mil

PP/EVOH/PP—50 mil

Containers were made by using the same thermoforming method.

FIG. 7 shows containers thermoformed from Freshblend film laminated high impact polystyrene sheets

FIG. 8 shows cups thermoformed from Freshblend film laminated high impact polystyrene sheets

### Example 4

### Peelable Lidding Film Containing Freshblend

A peelable lidding film as shown in FIG. 2 can be made by laminating the following three materials:

Layer 1: Printed or reverse printed substrate—Polyolefin, PET, paper

Layer 2: Freshblend film—single or multilayer containing Freshblend as described above

Layer 3: Optional sealant layer—LDPE or acrylic based resin

The three layer or more materials can be heat or coating laminated to form a single entity in the range of 1 to 40 mil, preferably 2 to 10 mil. The laminate is then used as peelable lidding film for cups, trays, bowls and other containers for food packaging.

Although the invention has been illustrated and described herein with reference to specific embodiments, the invention is not intended to be limited to the details shown. Rather, various modifications may be made in the details within the scope and range of equivalents of the claims and without departing from the invention. Accordingly, it is intended that the appended claims cover all such variations as fall within the spirit and scope of the invention.

1. A method for making an oxygen adsorbing tray having a layer including a finely dispersed iron/salt particles in a polymer matrix comprising pre-coating 1-25 um mean particle size iron with at least one or more activating and acidifying powdered components, mixing this oxygen scavenger with a polymer in the solid state prior to melt extrusion into a compound; treating the pellets or iron/salt powder with a surfactant prior to mixing forming a film from the extrusion and laminating the film to a tray.

2. A container for a material that degrades in the presence of oxygen comprising an oxygen scavenging film that consists of three or more layers with the oxygen scavenging particulates made in accordance with claim 1 located between other layers and a tray sealed along its edges to the film.

3. A pouch, bag, flexible enclosure or container that consists of the oxygen scavenging films in accordance with claim 1, formed as inserts, laminates or as a part of the multilayer structure, wherein the oxygen scavenging films deliver the oxygen absorbing performance in the enclosure.

4. A pouch, bag, or a flexible enclosure that consists of oxygen scavenger in accordance with claim 1 in the package as a part of the packaging or graphic design.

5. A container for a product that degrades in the presence of oxygen comprising a tray laminated with a film made from finely dispersed iron/salt particles in a polymer matrix comprising 1-25 um mean particle size iron pre-coated with at least one or more activating and acidifying powdered components and treated with a surfactant prior to mixing with a polymer in the solid state prior to melt extrusion into a compound.

6. The container of claim 5 having a high clarity with minimal visible agglomerates comprising three or more plastic layers with the oxygen scavenging particulates located between other layers.

7. A pouch, bag, flexible enclosure or container comprising an oxygen scavenging film in accordance with claim 5, in the form of inserts, laminates or as a part of the multilayer structure, wherein the oxygen scavenging films deliver the oxygen absorbing performance in the enclosure.

8. A pouch, bag, or a flexible enclosure that consists of an oxygen scavenger in accordance with claim 5 in the package as a part of the packaging or graphic design.

9. A thermoformed food container comprising a non oxygen scavenging base and an oxygen scavenging film laminated to the inside of the base.

10. The container of claim 9 in which the film comprises an oxygen scavenger and a moisture absorber.

11. The container of claim 9 in which the base comprises one of paper, cardboard, foam and plastic.

12. A food container comprising a base and a peelable oxygen scavenging film sealed to the base.

13. The container of claim 12 in which the film is sealed to the base by one of a heat seal and a coating seal.

14. The container of claim 9 in which the base comprises a foam formed from one or more of polystyrene, styrene-butadiene copolymers, styrene-ethylene copolymer, polypropylene, polyethylene, polyurethane, and copolymers or derivatives of any of them.

15. The food container of claim 12 in which the base comprises a foam formed from one or more of polystyrene, styrene-butadiene copolymers, styrene-ethylene copolymer, polypropylene, polyethylene, polyurethane, and copolymers or derivatives of any of them.

16. The food container of claim 15 in which the peelable film comprises a substrate formed from one or more of polypropylene, polyethylene, ethylene vinyl alcohol, polyethylene teraphthalate, nylon, poly lactic acid, and polystyrene.

17. The food container of claim 16 in which the film comprises a multi layer film having one or more adhesive layers.
